(19) United States
(12) Patent Application Publication
(10) Pub. No.: US 2024/0410799 A1
(43) Pub. Date: Dec. 12, 2024

(54) TWO-DIMENSIONAL SUSPENDED FLUIDIC SAMPLE DELIVERY USING ACOUSTIC FOCUSING

(71) Applicant: The Regents of the University of California, Oakland, CA (US)

(72) Inventor: Yanbao Ma, Merced, CA (US)

(21) Appl. No.: 18/737,683

(22) Filed: Jun. 7, 2024

Related U.S. Application Data
(60) Provisional application No. 63/471,980, filed on Jun. 9, 2023.

(51) Int. Cl. G01N 1/40; G01N 1/10; G01N 1/14; G01N 15/00

(52) U.S. Cl. CPC G01N 1/4077; G01N 1/10; G01N 15/00; G01N 2001/1025; G01N 2001/1472; G01N 2015/0053

(57) ABSTRACT

In various examples, an apparatus, system, and method for focusing particles within a two-dimensional suspended fluidic flow are described. A fluid is passed through a two-dimensional channel. The fluid contains particles. An acoustic signal is provided through the fluid channel substantially perpendicular to the two-dimensional fluid flow to align the particles. Characteristics of the particles within the flow, including amount and/or distribution, are determined via optical techniques. Other apparatuses, systems, and methods are disclosed.

### PRIORITY

This application claims the benefit of priority to U.S. Provisional Patent Application No. 63/471,980 titled “TWO-DIMENSIONAL SUSPENDED FLUIDIC SAMPLE DELIVERY USING ACOUSTIC FOCUSING” and filed on Jun. 9, 2023, the entire contents of which is hereby incorporated herein by reference in its entirety.

### FIELD OF THE DISCLOSURE

The present subject matter relates to two-dimensional suspended fluidic sample delivery. In particular, the present disclosure relates to a two-dimensional suspended fluidic sample delivery system with acoustic focusing to align particles such as microparticles and nanoparticles, suspended within the two-dimensional fluidic flow.

### BACKGROUND

Fluidic systems are widely used in, for example, sample preparation in chemical, biological, and biomedical operations that are applicable for diagnostic and therapeutic operations with higher efficiency as well as higher repeatability and reproducibility than other techniques. Traditional three-dimensional microfluidic systems suffer from low mixing efficiency and high pumping power because of high channel wall friction, thereby hindering high-speed bioassay or detection. In addition, the use of solid walls in the microfluidic systems may affect the manipulation and optical detection of microparticles and nanoparticles.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a schematic of a two-dimensional suspended fluidic system in accordance with at least one example of this disclosure.

FIG. 2 shows a method in accordance with at least one example of this disclosure.

FIG. 3 illustrates a block diagram of a device in accordance with some embodiments.

### DETAILED DESCRIPTION

A two-dimensional suspended fluidic system may be used to overcome low mixing efficiency and high pumping power issues that are present in conventional three-dimensional fluidic systems. Such a two-dimensional suspended fluidic system may be used for the delivery of microparticles and/or nanoparticles, which are even more sensitive to the issues above. As disclosed herein, an active acoustic focusing device may be used to align the particles towards the centerline of a two-dimensional suspended fluidic channel in the two-dimensional suspended fluidic system, which enables flow cytometry and single particle detection.

A two-dimensional suspended fluidic system refers to a setup or configuration where a fluid membrane is confined to a two-dimensional plane, typically suspended by a solid substrate or other means. In this system, the fluid is constrained in two dimensions, forming a thin liquid membrane (two-dimensional flow) with a thickness typically ranging from 10 nanometers to 10 microns and the remaining dimensions relatively unconstrained (e.g., constrained only by the dimensions of the device used to form the flow). The suspended nature of the two-dimensional suspended fluidic system allows for accurate control and manipulation of the fluid layer, enabling studies of various phenomena such as fluid flow, interfacial dynamics, surface interactions, and transport processes in a confined environment. Such systems may find applications in fields such as microfluidics, nanotechnology, surface science, and biotechnology, offering unique opportunities for investigating fluid behavior at the nanoscale and exploring novel functionalities for various technological advancements.

Disclosed herein are two-dimensional suspended fluidic systems that allow for high-speed delivery of microparticles and/or nanoparticles, and which can overcome various drawbacks of traditional systems, such as low flow velocity, high pressure drop, slow mixing, and high pumping power, associated with the traditional microfluidic sample delivery systems. The high-speed delivery of microparticles and/or nanoparticles in two-dimensional suspended fluidic systems disclosed herein can be applied to, for example, flow cytometry, serial crystallography, and rapid single cell or particle detection, among others. To minimize sample waste, an active acoustic focusing device can be applied to align microparticles and/or nanoparticles towards the centerline of the channel for bioassay. In various embodiments, the acoustic focusing device may adjust positions of the particles within the channel such that the particles avoid contact with the side surfaces of the channel (i.e., the centerline or a different line that is not equidistant between the side surfaces).

The two-dimensional suspended fluidic systems disclosed herein have several advantages. These advantages include that the two-dimensional suspended nature of the structure mitigates or eliminates wall friction from top and/or bottom surfaces of the structure. Another advantage is that friction and other effects on bioassay/detection from wall surfaces are also mitigated or eliminated due to the lack of surfaces with which the flow interacts given the two-dimensional suspended nature of the flow.

The above discussion is intended to provide an overview of subject matter of the disclosed subject-matter. It is not intended to provide an exclusive or exhaustive explanation of the disclosed subject-matter. The description below is included to provide further information about the disclosed subject-matter.

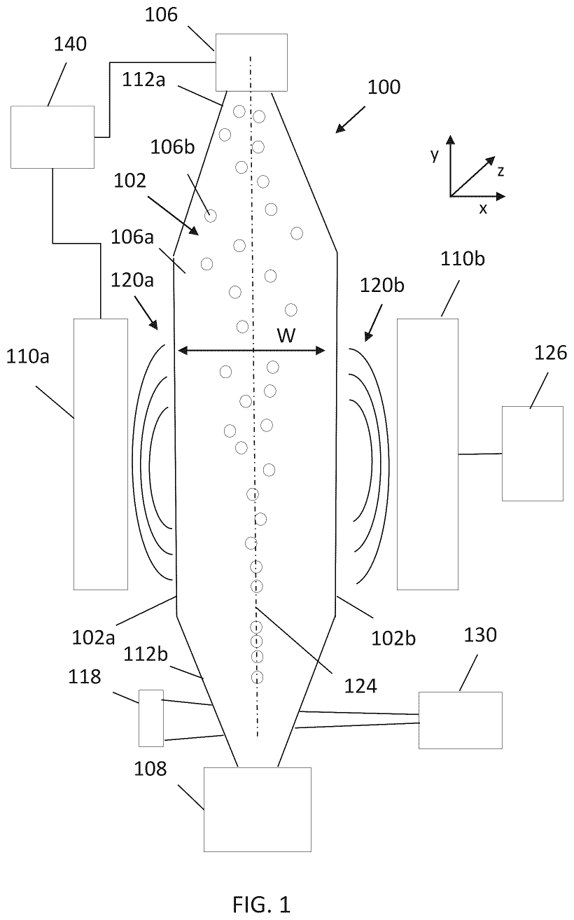

FIG. 1 shows a schematic diagram of a two-dimensional suspended fluidic system 100, in accordance with at least one example of this disclosure. The two-dimensional suspended fluidic system 100 may include a channel 102 defined by a first surface 102a and a second surface 102b located opposite the first surface 102a. The channel 102 may be formed in any shape, such as the substantially rectangular shape shown. In this case, the distance W between parallel portions of the first surface 102a and the second surface 102b may range from one or more microns to tens of mm or cm. In some cases, the first surface 102a and the second surface 102b may be separated by a larger distance, such as meters. The first surface 102a and the second surface 102b may form a thin film, e.g., having a depth (in the z-direction, as shown) about 1/100 or less of the distance W between the first surface 102a and the second surface 102b to thereby effectively form a 2D system. Thus, for example, for a width between the first surface 102a and the second surface 102b on the order of tens to hundreds of mm, the depth may be on the order of tens to hundreds of microns.

The channel 102 may have an inlet 112a and an outlet 112b. The channel 102 may carry a fluid 106a that contains particles 106b suspended therein to be measured. The particles 106b may be microparticles (e.g., that have a “diameter” of microns to less than a mm, where the term “diameter” may be interpreted as an aerodynamic diameter, a Stokes diameter, or some other metric not necessarily indicative of a geometric, spherical-particle diameter) and/or nanoparticles (e.g., that have a “diameter” of less than a micron down to a nanometer diameter). The fluid 106a is provided to the inlet 112a of the channel 102 from a source, such as a pump 106, and collected after exiting from the outlet 112b of the channel 102 at a collection vessel 108. The difference between the width and thickness of the channel 102 may essentially create a two-dimensional flow, whose flow characteristics are significantly different than a three-dimensional flow; for example, three-dimensional flows may have toroidal motion that may result in enhanced particle distribution unlike two-dimensional flows. This flow motion may permit the particles 106b in the two-dimensional flow of the channel 102 to be manipulated more easily than in a three-dimensional flow.

A first acoustic signal generator 110a and a second acoustic signal generator 110b are also provided respectively proximate (e.g., within a few cm of) or adjacent to each of the first surface 102a and second surface 102b of the channel 102, respectively. The first acoustic signal generator 110a and the second acoustic signal generator 110b are also referred to as acoustic focusing devices or speakers. The first acoustic signal generator 110a and the second acoustic signal generator 110b may extend substantially in parallel with and along substantially the entirety of at least the portion of the channel 102 that does not contain the inlet 112a or the outlet 112b. In other embodiments, one or both of the acoustic signal generator 110a and the second acoustic signal generator 110b may extend in a non-parallel direction, e.g., the acoustic signal generator 110a and the second acoustic signal generator 110b may be designed (e.g., curved) and/or positioned to adjust the acoustic waves produced to be of substantially uniform strength along a particular length. The first acoustic signal generator 110a and the second acoustic signal generator 110b may be symmetrically disposed around the channel 102. In other embodiments, the acoustic signal generator 110a and the second acoustic signal generator 110b may not be symmetrically disposed around the channel 102, for example, the acoustic signal generator 110a may be disposed at a different distance from the first surface 102a the second acoustic signal generator 110b is from the second surface 102b-which may permit a uniform flow in a non-orthogonal manner from the pump 106 to the collection vessel 108.

The first acoustic signal generator 110a and the second acoustic signal generator 110b may respectively produce acoustic signals 120a and 120b. The acoustic signals 120a and 120b may be directed substantially in the x (width) direction—substantially perpendicular to an axial direction of the channel 102 as shown in FIG. 1, and hence substantially perpendicular to the flow of particles 106b flowing through the channel 102. As shown in FIG. 1, the first acoustic signal generator 110a may be located proximate the first surface 102a and the second acoustic signal generator 110b may be located proximate the second surface 102b; the first acoustic signal generator 110a may be separate from the first surface 102a by the same distance as the second acoustic signal generator 110b is from the second surface 102b such that the first acoustic signal generator 110a and the second acoustic signal generator 110b are symmetric around the channel 102.

The first acoustic signal generator 110a and the second acoustic signal generator 110b may be driven by a signal generator 126 to generate symmetrical standing acoustic waves (the signal generator 126 is shown coupled only to the second acoustic signal generator 110b for simplicity). The standing acoustic waves may cause the particles 106b in the fluid 106a to be physically manipulated to arrange along a central axis 124 of the channel 102, shown by the dot-dashed line in FIG. 1. The standing acoustic waves may be controlled by the signal generator 126, which may be connected to the first acoustic signal generator 110a and the second acoustic signal generator 110b via wired or wireless connections. The acoustic waves may be generated sufficiently before the flow is initiated to generate the standing acoustic waves.

During operation, the fluid 106a and particles 106b suspended therein may flow from the pump 106 through the inlet 112a and into the channel 102. The pump 106 may be, for example, a hydraulic pump or peristaltic pump that pumps the fluid 106a or an electric pump that provides a voltage to the fluid 106a to drive the flow. The particles 106b may diffuse into a random arrangement in at least the inlet 112a. As the particles 106b then flow along the channel 102, the standing acoustic waves from the first acoustic signal generator 110a and the second acoustic signal generator 110b may manipulate the particles 106b in the two-dimensional flow toward the central axis 124 of the channel 102. As shown in FIG. 1, the standing acoustic waves are generated over a sufficient area with sufficient force such that the particles 106b eventually are disposed along the central axis 124 of the channel 102. The distribution of the particles 106b along the central axis 124 of the channel 102 may typically be non-uniform, although in other embodiments, the distribution of the particles 106b along the central axis 124 of the channel 102 may be further adjusted to be uniform. In other embodiments, the first acoustic signal generator 110a and the second acoustic signal generator 110b may be disposed non-symmetrically with respect to the central axis 124 or may be driven differently from each other such that the particles 106b may be aligned off axis to the central axis 124. In some embodiments, the length of the channel 102 may be dependent on the particle size, as well as the power of the standing acoustic waves from the first acoustic signal generator 110a and the second acoustic signal generator 110b. For example, a longer channel may be used for a polydisperse distribution to allow large particles within the distribution to be driven toward the central axis 124 of the channel 102.

After the particles 106b are substantially aligned along the central axis 124 of the channel 102, the amount and/or distribution of the particles 106b may be detected by a detector 118. The detector 118 may detect radiation emitted by a radiation source 130. Upon reading and understanding the disclosed subject matter, a person of ordinary skill in the art will recognize that the radiation source 130 may comprise another source type, such as a visible, IR, or UV optical source, such as a monochromatic laser or a broadband light source. The radiation source 130 may emit x-rays or radiation of other wavelengths for, e.g., diffraction-based detection by the detector 118. The radiation source 130, the detector 118, and detection technique may be selected specifically for two-dimensional usage provided by the two-dimensional suspended fluidic system 100. The time period over which the detector 118 operates may be predetermined or may be based on other factors, such as accuracy level of the system 100, a flow rate of the particles 106b, and/or a particle type or size of the particles 106b, among others. The radiation source/detector pair may be disposed to detect the particles 106b. In some cases, multiple radiation source/detector pairs may be used.

Although only one source of fluid 106a and particles 106b is shown, other sources of different fluids and particles may be present and combined into a single two-dimensional flow similar to that shown in FIG. 1. The flow rates, types, and/or sizes of the particles may be different. Each of the fluids containing the suspended particles may be intermixed or otherwise combined into a single two-dimensional suspended fluid in the channel 102. The intermingled particles suspended therein may be affected in a similar manner by the standing acoustical waves generated by the first acoustic signal generator 110a and the second acoustic signal generator 110b to align the particles along or near to the central axis 124 of the channel 102 (i.e., substantially align the particles or drive particles within the two-dimensional flow toward a centerline of an axial direction of the two-dimensional flow). In some embodiments, substantially aligning the particles at the centerline (central axis 124) is that, after alignment, the centers of the particles are disposed at the centerline within about 1-10% of the width of the channel 102. The concentration and/or distribution of the different types of particles may be detected by one or more radiation source/detector combinations. The sources may be colinear and the fluids directed via different inlets to a common channel and outlet (e.g., disposed in a substantially “Y” type shape). In other embodiments, one or more of the sources may be offset in the thickness direction from the common channel and routed to the common channel via inlets.

A controller 140 may be used to wired or wirelessly control one or more of the pump 106, the acoustic signal generators 110a, 110b, the signal generator 126, the radiation source 130, and the detector 118 (only two connections are shown for convenience). The controller 140 may include a processor and may determine the information described herein. Moreover, the controller 140 may be used to adjust the flow rate and/or particle mix of each pump 106 based on the information obtained from the detector 118.

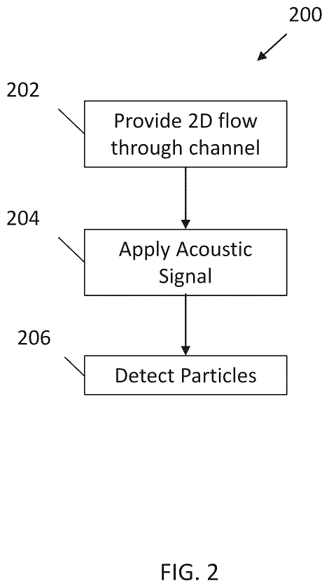

FIG. 2 shows a method 200 for focusing particles within a two-dimensional suspended fluidic system in accordance with at least one example of this disclosure. Method 200 may begin at operation 202 where a fluid is introduced to a channel through an inlet. The fluid may be pumped or otherwise provided to the channel. The fluid has particles, such as micro or nano particles, suspended therein. The flow is a two-dimensional flow, in which the distance between opposing sides of the channel is larger than the thickness of the flow by at least two orders of magnitude (although larger than the size of the particles suspended in the fluid). The fluid may be a single fluid (from a single source) containing particles of the same size or different sizes (e.g., monodispersed particles or polydispersed particles, in a colloidal suspension within a fluid), or the single fluid may be mixed (e.g., from several sources) in multiple inlets such that two or more separate fluids with different particles flow through the channel.

As the fluid is flowing through the channel, acoustic signals may be generated and directed at operation 204 through the channel substantially perpendicular to the fluid flow. Each acoustic signal may be a standing acoustic wave. The standing acoustic waves may oppose each other to set up balancing forces within the fluid. Specifically, as the fluid flows through the channel, the acoustic signals may align the particles into a substantially linear arrangement (e.g., within about a characteristic particle size (e.g., a particle diameter or another metric depending at least partially on, for example, a morphology of the particle) from the center of the linear arrangement). The linear arrangement may be along the center of the channel, as shown in FIG. 1, when the standing waves are balanced and symmetrically disposed around the center of the channel.

After the particles have been aligned, the particles may be detected by monitoring the flow at or near an outlet of the channel at operation 206. The acoustic signal may be adjusted based on the conditions of the fluid at the outlet. For example, if the particles suspended in the fluid are not aligned correctly or as expected, then the frequency and/or amplitude of the acoustic signal may be changed to better align the particles to permit improved detection. The particle detection may be used to determine the amount and/or distribution of particles, among others, in the fluid. This detection may be used in various embodiments for particle preparation, drug encapsulation, particle delivery, and targeting, cell analysis, diagnosis, and cell culture uses, among others. The system described herein may be used, for example, in biological applications such as electrophoresis, isoelectric focusing, immunoassays, flow cytometry, sample injection in mass spectrometry, polymerase chain reaction (PCR) amplification, DNA analysis, separation and manipulation of cells, and cell patterning. Other applications include detection, analysis, and determination of countermeasures against biological threats, pH control/drug administration, chemical gradient generation, control of polymers, silicon, or glass (for example) for semiconductor chip fabrication, as well as a host of other applications. That is, the two-dimensional flow described herein may be used not only for detection and analysis-based applications, but also material fabrication due to the enhanced dimensional control afforded by the system.

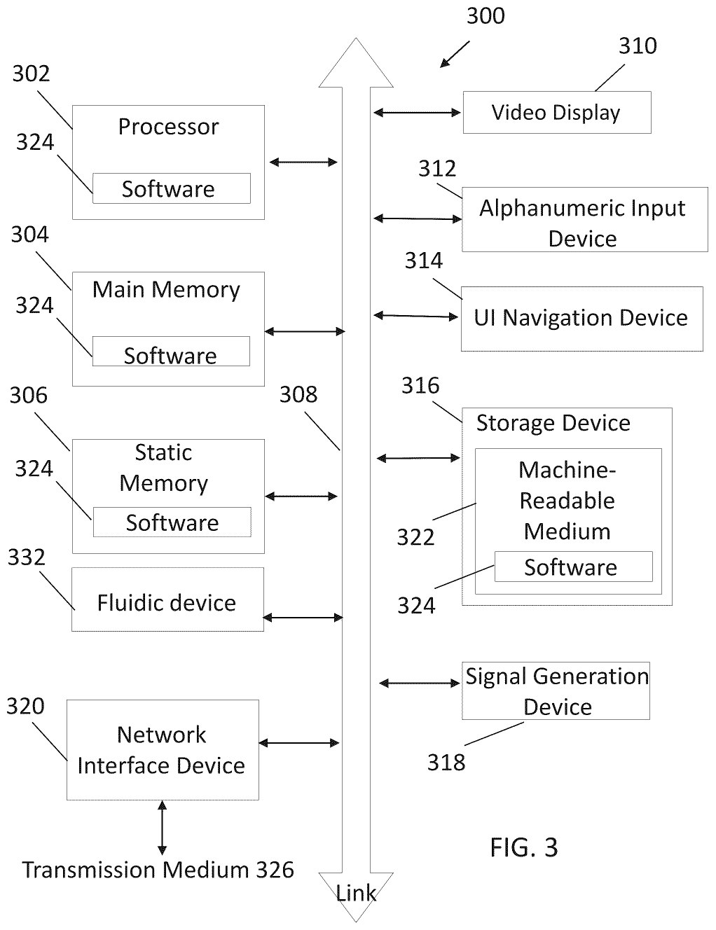

FIG. 3 illustrates a block diagram of a device in accordance with some embodiments. Some of the components shown in FIG. 3 may not be present, but are described here for completeness. The device 300 may operate as a standalone device or may be connected (e.g., networked) to other devices. The device may be any machine capable of providing the functionality shown in FIG. 1, as well as capable of executing instructions (sequential or otherwise) that specify actions to be taken by that machine. The device 300 includes a fluidic device 332 described in FIG. 1 and that includes the channel.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits shown in FIG. 3 may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The device 300 may include a hardware processor (or equivalently processing circuitry) 302 (e.g., a central processing unit (CPU), a GPU, a hardware processor core, or any combination thereof), a main memory 304 and a static memory 306, some or all of which may communicate with each other via an interlink (e.g., bus) 308. The main memory 304 may contain any or all of removable storage and non-removable storage, volatile memory or non-volatile memory. The device 300 may further include a display unit 310 such as a video display, an alphanumeric input device 312 (e.g., a keyboard), and a user interface (UI) navigation device 314 (e.g., a mouse). In an example, the display unit 310, input device 312 and UI navigation device 314 may be a touch screen display. The device 300 may additionally include a storage device (e.g., drive unit) 316, a signal generation device 318 (e.g., the speakers shown in FIG. 1), a network interface device 320, and one or more sensors, such as a global positioning system (GPS) sensor, compass, accelerometer, or other sensor. The device 300 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 316 may include a non-transitory machine readable medium 322 (hereinafter simply referred to as machine readable medium) on which is stored one or more sets of data structures or instructions 324 (e.g., software) embodying or utilized by any one or more of the techniques or functions described herein. The instructions 324 may also reside, completely or at least partially, within the main memory 304, within static memory 306, and/or within the hardware processor 302 during execution thereof by the device 300. While the machine readable medium 322 is illustrated as a single medium, the term “machine readable medium” may include a single medium or multiple media (e.g., a centralized or distributed database, and/or associated caches and servers) configured to store the one or more instructions 324.

The term “machine readable medium” may include any medium that is capable of storing, encoding, or carrying instructions for execution by the device 300 and that cause the device 300 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 324 may further be transmitted or received over a communications network using a transmission medium 326 via the network interface device 320 utilizing any one of a number of wireless local area network (WLAN) transfer protocols. In an example, the network interface device 320 may include one or more physical jacks or one or more antennas to connect to the transmission medium 326. The network interface device 320 may provide results and/or analysis to external devices via the transmission medium 326

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

### Additional Notes

Example 1 is a two-dimensional suspended fluidic system comprising: a first surface; a second surface located opposite the first surface, the first surface and the second surface defining a width of a two-dimensional fluid channel, the two-dimensional fluid channel having an inlet and an outlet; and an acoustic focusing device configured to emit standing acoustic waves into a two-dimensional fluid flow within the two-dimensional fluid channel to drive particles within the two-dimensional fluid flow toward a centerline of an axial direction of the two-dimensional fluid channel.

In Example 2, the subject matter of Example 1 includes, wherein the acoustic focusing device comprises: a first speaker located proximate the first surface; and a second speaker located proximate the second surface.

In Example 3, the subject matter of Example 2 includes, wherein the first speaker and the second speaker are symmetrically disposed around the two-dimensional fluid channel.

In Example 4, the subject matter of Examples 1-3 includes, a pump configured to supply fluid of the two-dimensional fluid flow to the two-dimensional fluid channel; and a collection vessel configured to retain the fluid after passing through the two-dimensional fluid channel.

In Example 5, the subject matter of Example 4 includes, wherein the pump is a hydraulic pump configured to pump fluid into the two-dimensional fluid channel.

In Example 6, the subject matter of any one of Examples 4-5 includes, wherein the pump is an electric pump configured to provide a voltage to drive fluid into the two-dimensional fluid channel.

In Example 7, the subject matter of any one of Examples 1-6 includes, wherein the two-dimensional fluid flow comprises at least one of microparticles or nanoparticles contained within a colloidal suspension.

In Example 8, the subject matter of any one of Examples 1-7 includes, wherein the acoustic focusing device is configured to align the particles substantially at a centerline of the two-dimensional fluid channel.

In Example 9, the subject matter of any one of Examples 1-8 includes, wherein the acoustic focusing device is configured to adjust positions of the particles substantially to avoid contact with the first surface and the second surface.

In Example 10, the subject matter of any one of Examples 1-9 includes, a radiation source configured to emit radiation impinging on aligned particles within the two-dimensional fluid flow and a detector configured to detect radiation that has impinged on the aligned particles to determine at least one metric selected from metrics including of a concentration and a distribution of the aligned particles.

In Example 11, the subject matter of Example 10 includes, wherein a time period over which the detector is configured to operate depends on at least one of an accuracy level of the system, a flow rate of the particles, particle type of the particles, and a particle size of the particles.

In Example 12, the subject matter of any one of Examples 1-11 includes, a plurality of sources configured to supply fluid of the two-dimensional fluid flow to the two-dimensional fluid channel and a collection vessel configured to retain the fluid after passing through the two-dimensional fluid channel, each of the sources configured to supply particles that differ in at least one of type, size, and flow rate from at least one other of the sources.

In Example 13, the subject matter of any one of Examples 10-12 includes, wherein the sources are substantially colinear, and fluid from each of the sources are to be directed via a different inlet to a common channel and outlet.

In Example 14, the subject matter of any one of Examples 10-13 includes, wherein at least one of the sources is offset in a direction perpendicular to the two dimensional flow from a common channel and routed to the common channel via an inlet.

Example 15 is a two-dimensional suspended fluidic system comprising: a fluid channel defined by a first surface and a second surface; and an acoustic focusing device configured to emit acoustic waves into a two-dimensional flow passing through the fluid channel to drive particles within the two-dimensional flow toward a centerline of an axial direction of the two-dimensional flow.

In Example 16, the subject matter of Example 15 includes, wherein the acoustic focusing device comprises: a first speaker located proximate the first surface; and a second speaker located proximate the second surface, the first speaker and the second speaker being symmetrically disposed around the fluid channel.

In Example 17, the subject matter of any one of Examples 15-16 includes, wherein the acoustic focusing device is configured to align the particles substantially at a centerline of the fluid channel.

In Example 18, the subject matter of any one of Examples 15-17 includes, a plurality of sources configured to supply fluid of the two-dimensional fluid flow to the two-dimensional fluid channel, each of the sources configured to supply particles that differ in at least one of type, size, and flow rate from at least one other of the sources; and a collection vessel configured to retain the fluid after passing through the two-dimensional fluid channel.

Example 19 is a method for focusing particles within a two-dimensional suspended fluidic flow, the method comprising: passing a fluid through a two-dimensional fluid channel, the fluid containing the particles; and directing an acoustic signal through the two-dimensional fluid channel substantially perpendicular to a two-dimensional fluid flow of the fluid to align the particles by driving particles within the two-dimensional fluid flow toward a centerline of an axial direction of the two-dimensional fluid flow.

In Example 20, the subject matter of Example 19 includes, wherein the acoustic signal comprises a standing acoustic wave.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above detailed description includes references to the accompanying drawings, which form a part of the detailed description. The drawings show, by way of illustration, specific embodiments in which the disclosed subject-matter can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the disclosed subject-matter should be determined with reference to the appended claims, along with the full scope of equivalents to which such claims are entitled.

What is claimed is:

1. A two-dimensional suspended fluidic system comprising:
a first surface;
a second surface located opposite the first surface, the first surface and the second surface defining a width of a two-dimensional fluid channel, the two-dimensional fluid channel having an inlet and an outlet; and
an acoustic focusing device configured to emit standing acoustic waves into a two-dimensional fluid flow within the two-dimensional fluid channel to drive particles within the two-dimensional fluid flow toward a centerline of an axial direction of the two-dimensional fluid channel.

2. The system of claim 1, wherein the acoustic focusing device comprises:
a first speaker located proximate the first surface; and
a second speaker located proximate the second surface.

3. The system of claim 2, wherein the first speaker and the second speaker are symmetrically disposed around the two-dimensional fluid channel.

4. The system of claim 1, further comprising:
a pump configured to supply fluid of the two-dimensional fluid flow to the two-dimensional fluid channel; and
a collection vessel configured to retain the fluid after passing through the two-dimensional fluid channel.

5. The system of claim 4, wherein the pump is a hydraulic pump configured to pump fluid into the two-dimensional fluid channel.

6. The system of claim 4, wherein the pump is an electric pump configured to provide a voltage to drive fluid into the two-dimensional fluid channel.

7. The system of claim 1, wherein the two-dimensional fluid flow comprises at least one of microparticles or nanoparticles contained within a colloidal suspension.

8. The system of claim 1, wherein the acoustic focusing device is configured to align the particles substantially at a centerline of the two-dimensional fluid channel.

9. The system of claim 1, wherein the acoustic focusing device is configured to adjust positions of the particles substantially to avoid contact with the first surface and the second surface.

10. The system of claim 1, further comprising a radiation source configured to emit radiation impinging on aligned particles within the two-dimensional fluid flow and a detector configured to detect radiation that has impinged on the aligned particles to determine at least one metric selected from metrics including of a concentration and a distribution of the aligned particles.

11. The system of claim 10, wherein a time period over which the detector is configured to operate depends on at least one of an accuracy level of the system, a flow rate of the particles, particle type of the particles, and a particle size of the particles.

12. The system of claim 1, further comprising a plurality of sources configured to supply fluid of the two-dimensional fluid flow to the two-dimensional fluid channel and a collection vessel configured to retain the fluid after passing through the two-dimensional fluid channel, each of the sources configured to supply particles that differ in at least one of type, size, and flow rate from at least one other of the sources.

13. The system of claim 10, wherein the sources are substantially colinear, and fluid from each of the sources are to be directed via a different inlet to a common channel and outlet.

14. The system of claim 10, wherein at least one of the sources is offset in a direction perpendicular to the two dimensional flow from a common channel and routed to the common channel via an inlet.

15. A two-dimensional suspended fluidic system comprising:
a fluid channel defined by a first surface and a second surface; and
an acoustic focusing device configured to emit acoustic waves into a two-dimensional flow passing through the fluid channel to drive particles within the two-dimensional flow toward a centerline of an axial direction of the two-dimensional flow.

16. The system of claim 15, wherein the acoustic focusing device comprises:
a first speaker located proximate the first surface; and
a second speaker located proximate the second surface, the first speaker and the second speaker being symmetrically disposed around the fluid channel.

17. The system of claim 15, wherein the acoustic focusing device is configured to align the particles substantially at a centerline of the fluid channel.

18. The system of claim 15, further comprising:
a plurality of sources configured to supply fluid of the two-dimensional fluid flow to the two-dimensional fluid channel, each of the sources configured to supply particles that differ in at least one of type, size, and flow rate from at least one other of the sources; and
a collection vessel configured to retain the fluid after passing through the two-dimensional fluid channel.

19. A method for focusing particles within a two-dimensional suspended fluidic flow, the method comprising:
passing a fluid through a two-dimensional fluid channel, the fluid containing the particles; and
directing an acoustic signal through the two-dimensional fluid channel substantially perpendicular to a two-dimensional fluid flow of the fluid to align the particles by driving particles within the two-dimensional fluid flow toward a centerline of an axial direction of the two-dimensional fluid flow.
